(19) United States
(12) Patent Application Publication
(10) Pub. No.: US 2024/0013317 A1
(43) Pub. Date: Jan. 11, 2024

(54) VOUCHER VERIFICATION METHOD AND VOUCHER VERIFICATION SYSTEM

(71) Applicant: Semiconductor Energy Laboratory Co., Ltd., Atsugi-shi (JP)

(72) Inventors: Junpei MOMO, Sagamihara (JP); Tatsuya OKANO, Isehara (JP)

(21) Appl. No.: 18/035,146

(22) PCT Filed: Nov. 2, 2021
(86) PCT No.: PCT/IB2021/060114

§ 371 Date: May 3, 2023

(30) Foreign Application Priority Data
Nov. 13, 2020 (JP) 2020-189252

(51) Int. Cl. G06Q 40/12; G06N 3/0464; G06N 3/09

(52) U.S. Cl. CPC G06Q 40/12; G06N 3/0464; G06N 3/09

(57) ABSTRACT

Provided are a voucher verification method and a voucher verification system for automatically checking agreement between a voucher and accounting data. A processing portion receives accounting data, voucher image data, and text data, extracts a local image feature value from the voucher image data, generates, using a learned determination model, a first vector based on the accounting data and a second vector based on the local image feature value and the text data, calculates similarity between the first vector and the second vector, determines whether the accounting data agrees with the voucher using the calculated similarity, and outputs a determination result. Note that the text data is data extracted from the voucher image data by optical character recognition.

### TECHNICAL FIELD

One embodiment of the present invention relates to a voucher verification method. Another embodiment of the present invention relates to a voucher verification system.

### BACKGROUND ART

As accounting processing of vouchers, input of accounting data, an audit of an accounting report, and the like are given. Accounting software that helps accounting processing of vouchers is becoming popular. However, these operations need to be carried out by checking each voucher even with accounting software because paper-based vouchers are used in many cases. Therefore, the work efficiency is low. In recent years, a technique for enhancing the work efficiency of inputting accounting data by optical character recognition (OCR) has been developed. Patent Document 1 discloses accounting software in which OCR is performed on a voucher to create a recorded electronic business form so that accounting data is entered into an account book.

### REFERENCE

### Patent Document

[Patent Document 1] Japanese Published Patent Application No. 2020-57186

### SUMMARY OF THE INVENTION

### Problems to be Solved by the Invention

One of auditing operations on an accounting report is to verify agreement between accounting data entered into accounting software and vouchers (i.e., vouching). Since paper-based vouchers are used in many cases and the form of a voucher varies from company to company, it is difficult to mechanically read a voucher. Thus, there is no other choice than to rely on human eyes in verifying agreement between accounting data and a voucher.

It is possible to capture an image of a paper-based voucher with a device such as a scanner to extract a character string from the image by OCR. However, various kinds of noise are included in the character string extracted by OCR and thus the character string is incomplete in some cases. That is, a character string extracted by OCR might not be accurate (correct) enough to be used for checking accounting data.

In the case where a value and the like are extracted by OCR, it is difficult to determine what the value indicates only by OCR. Thus, a human needs to determine which piece of accounting data entered into accounting software should be compared with the value extracted by OCR.

In view of the above, an object of one embodiment of the present invention is to provide a voucher verification method for automatically checking agreement between a voucher and accounting data. Another object of one embodiment of the present invention is to provide a voucher verification method for checking agreement between a voucher and accounting data regardless of OCR performance. Another object of one embodiment of the present invention is to provide a voucher verification system for automatically checking agreement between a voucher and accounting data. Another object of one embodiment of the present invention is to provide a voucher verification system for checking agreement between a voucher and accounting data regardless of OCR performance. Note that “automatically checking” means to check agreement between a voucher and accounting data partly or entirely using a system. Thus, “automatically” in this specification and the like can be rephrased as “systematically”.

Note that the description of these objects does not preclude the existence of other objects. In one embodiment of the present invention, there is no need to achieve all these objects. Other objects are apparent from and can be derived from the description of the specification, the drawings, the claims, and the like.

### Means for Solving the Problems

One embodiment of the present invention is a voucher verification method for checking agreement between accounting data and a voucher using a processing portion. The processing portion receives first accounting data, image data of a first voucher, and first text data, extracts a first local image feature value from the image data of the first voucher, makes determination of whether the first accounting data agrees with the first voucher on the basis of the first local image feature value, the first text data, and the first accounting data using a learned determination model, and outputs a result of the determination. The first text data is data extracted from the image data of the first voucher by optical character recognition.

Another embodiment of the present invention is a voucher verification method for checking agreement between accounting data and a voucher using a processing portion. The processing portion receives first accounting data, image data of a first voucher, and first text data, extracts a first local image feature value from the image data of the first voucher, generates a first vector on the basis of the first accounting data using a learned determination model, generates a second vector on the basis of the first local image feature value and the first text data using the learned determination model, calculates similarity between the first vector and the second vector, makes determination of whether the first accounting data agrees with the first voucher using the calculated similarity, and outputs a result of the determination. The first text data is data extracted from the image data of the first voucher by optical character recognition.

Another embodiment of the present invention is a voucher verification method for checking agreement between accounting data and a voucher using a processing portion. The processing portion receives first accounting data and image data of a first voucher, extracts first text data from the image data of the first voucher by optical character recognition, extracts a first local image feature value from the image data of the first voucher, generates a first vector on the basis of the first accounting data using a learned determination model, generates a second vector on the basis of the first local image feature value and the first text data using the learned determination model, calculates similarity between the first vector and the second vector, makes determination of whether the first accounting data agrees with the first voucher using the calculated similarity, and outputs a result of the determination.

In the learned determination model in the above voucher verification method, it is preferable that first learning for generating a vector be performed using second text data, and after the first learning, second learning for generating a vector be performed using a second local image feature value, third text data, and second accounting data. Furthermore, it is preferable that the second accounting data be data corresponding to a second voucher, the second local image feature value be extracted from image data of the second voucher, and the third text data be data extracted from the image data of the second voucher.

In the above voucher verification method, the second learning is preferably supervised learning.

In the above voucher verification method, the first accounting data preferably includes data input manually by a user with reference to the first voucher.

In the above voucher verification method, the first accounting data preferably includes data input mechanically on the basis of the first voucher.

Another embodiment of the present invention is a voucher verification system including a memory portion, a receiving portion, and a processing portion. The memory portion stores a learned determination model. The receiving portion has a function of receiving first accounting data, image data of a first voucher, and first text data. The processing portion has a function of extracting a first local image feature value from the image data of the first voucher; a function of generating a first vector on the basis of the first accounting data using the learned determination model; a function of generating a second vector on the basis of the first local image feature value and the first text data using the learned determination model; a function of calculating similarity between the first vector and the second vector; and a function of making determination of whether the first accounting data agrees with the first voucher using the calculated similarity. The first text data is data extracted from the image data of the first voucher by optical character recognition.

In the learned determination model in the above voucher verification system, it is preferable that first learning for generating a vector be performed using second text data, and after the first learning, second learning for generating a vector be performed using a second local image feature value, third text data, and second accounting data. Furthermore, it is preferable that the second accounting data be data corresponding to a second voucher, the second local image feature value be extracted from image data of the second voucher, and the third text data be data extracted from the image data of the second voucher.

In the above voucher verification system, the second learning is preferably supervised learning.

It is preferable that the above voucher verification system include a display portion and the display portion have a function of displaying a result of the determination.

### Effect of the Invention

One embodiment of the present invention can provide a voucher verification method for automatically checking agreement between a voucher and accounting data. Another embodiment of the present invention can provide a voucher verification method for checking agreement between a voucher and accounting data regardless of OCR performance. Another embodiment of the present invention can provide a voucher verification system for automatically checking agreement between a voucher and accounting data. Another embodiment of the present invention can provide a voucher verification system for checking agreement between a voucher and accounting data regardless of OCR performance.

Note that the effects of one embodiment of the present invention are not limited to the effects listed above. The effects listed above do not preclude the existence of other effects. The other effects are effects that are not described in this section and will be described below. The effects that are not described in this section can be derived from the descriptions of the specification, the drawings, and the like and can be extracted from these descriptions by those skilled in the art. Note that one embodiment of the present invention has at least one of the effects listed above and/or the other effects. Accordingly, depending on the case, one embodiment of the present invention does not have the effects listed above in some cases.

### BRIEF DESCRIPTION OF THE DRAWINGS

FIG. 1A is a diagram illustrating an example of a voucher verification system of one embodiment of the present invention. FIG. 1B is a diagram illustrating an example of a processing portion of one embodiment of the present invention.

FIG. 2A is a diagram illustrating an example of a voucher verification system of one embodiment of the present invention. FIG. 2B is a diagram illustrating an example of a processing portion of one embodiment of the present invention.

FIG. 3 is a flowchart showing an example of a voucher verification method of one embodiment of the present invention.

FIG. 4 is a flowchart showing an example of a voucher verification method of one embodiment of the present invention.

FIG. 5 is a flowchart showing an example of a voucher verification method of one embodiment of the present invention.

FIG. 6 is a flowchart showing an example of a learning method of a determination model of one embodiment of the present invention.

FIG. 7 is a diagram illustrating an example of a processing portion of one embodiment of the present invention.

FIG. 8 is a flowchart showing an example of steps of a processing verification method of one embodiment of the present invention.

FIG. 9 is a diagram illustrating an example of a processing portion of one embodiment of the present invention.

FIG. 10 is a flowchart showing an example of steps of a processing verification method of one embodiment of the present invention.

FIG. 11 is a diagram illustrating an example of hardware of a voucher verification system.

FIG. 12 is a diagram illustrating an example of hardware of a voucher verification system.

### MODE FOR CARRYING OUT THE INVENTION

Embodiments are described in detail with reference to the drawings. Note that the present invention is not limited to the following description, and it will be readily understood by those skilled in the art that modes and details of the present invention can be modified in various ways without departing from the spirit and scope of the present invention. Therefore, the present invention should not be construed as being limited to the description of embodiments below.

Note that in structures of the invention described below, the same portions or portions having similar functions are denoted by the same reference numerals in different drawings, and the description thereof is not repeated. Furthermore, the same hatch pattern is used for the portions having similar functions, and the portions are not especially denoted by reference numerals in some cases.

The position, size, range, or the like of each component illustrated in drawings does not represent the actual position, size, range, or the like in some cases for easy understanding. Therefore, the disclosed invention is not necessarily limited to the position, size, range, or the like disclosed in the drawings.

Furthermore, ordinal numbers such as “first”, “second”, and “third” used in this specification are used in order to avoid confusion among components, and the terms do not limit the components numerically.

In this specification and the like, character string data written on a voucher is simply referred to as a voucher in some cases. In other words, the simple term “voucher” refers to character string data written on a voucher in some cases.

In this specification and the like, of accounting data entered into accounting software, accounting data that has not gone through verification of agreement with a voucher (accounting data that has not been subjected to vouching) is referred to as unaudited accounting data in some cases. Furthermore, a voucher that has not gone through verification of agreement with accounting data entered into accounting software (a voucher that has not been subjected to vouching) is referred to as an unaudited voucher in some cases. That is, an unaudited voucher can also be referred to as a voucher to be audited or a voucher to be subjected to an audit.

In this specification and the like, of accounting data entered into accounting software, accounting data that has gone through verification of agreement with a voucher (accounting data that has been subjected to vouching) is referred to as audited accounting data in some cases. A voucher that has gone through verification of agreement with accounting data entered into accounting software (a voucher that has been subjected to vouching) is referred to as an audited voucher in some cases.

In this specification and the like, conversion of a character string (words, values, or the like, and a combination thereof) into a vector is referred to as “to generate a vector on the basis of a character string”. Note that the vector includes a low-dimensional compressed (dimensionally reduced) vector, a vector using distributed representation, and the like. Thus, in this specification and the like, “to generate a vector on the basis of a character string” can be rephrased as “to generate a low-dimensional compressed (dimensionally reduced) vector on the basis of a character string”, “to generate a vector using a model that has learned distributed representation, on the basis of a character string”, or the like.

Optical character recognition (OCR) is a mechanism of extracting text data from image data by recognizing a character in an image. Note that a device or software having an OCR function is sometimes simply referred to as OCR. Thus, in this specification and the like, OCR can be rephrased as a device having an OCR function or software having an OCR function in some cases.

### Embodiment 1

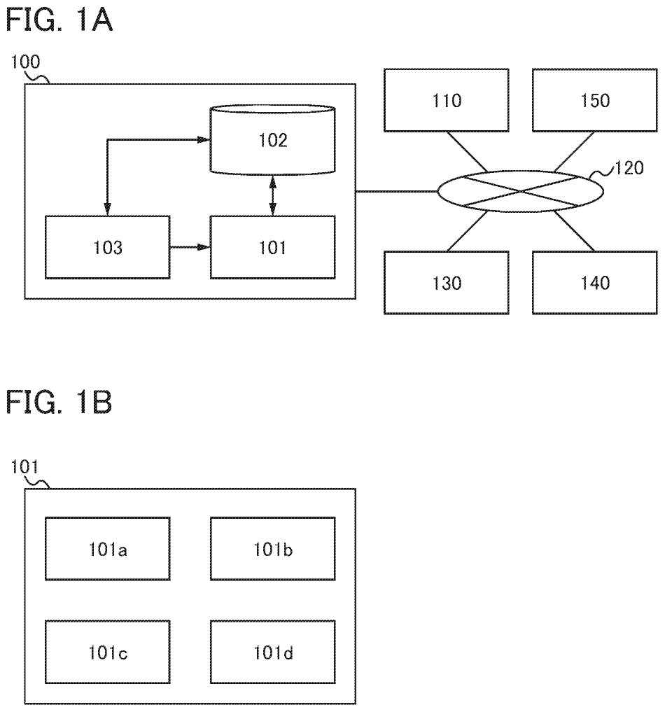

In this embodiment, a voucher verification system and a voucher verification method of embodiments of the present invention are described with reference to FIG. 1 to FIG. 10.

### <Voucher Verification System>

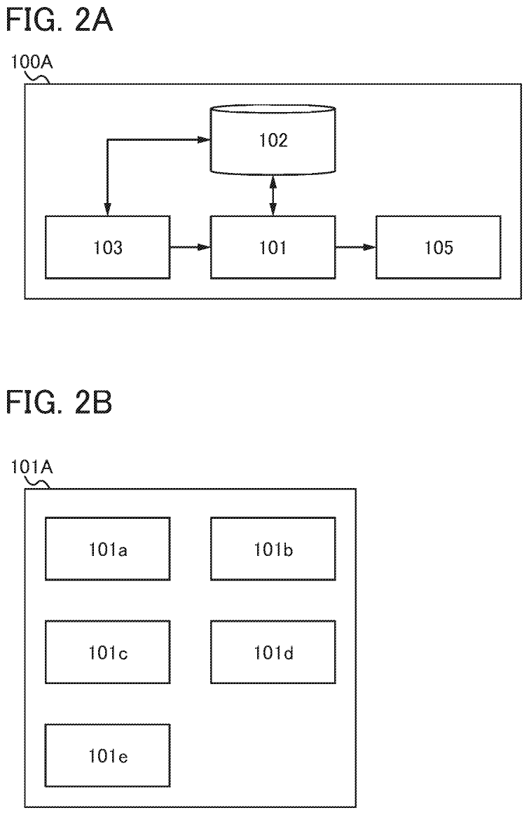

First, a voucher verification system of one embodiment of the present invention is described with reference to FIG. 1 and FIG. 2. The voucher verification system of one embodiment of the present invention is a system for checking agreement between an unaudited voucher and accounting data input on the basis of the unaudited voucher.

FIG. 1A is a diagram illustrating a structure of a voucher verification system 100.

The voucher verification system 100 includes at least a processing portion 101. The voucher verification system 100 illustrated in FIG. 1A includes the processing portion 101, a memory portion 102, and a receiving portion 103.

The voucher verification system 100 can be provided in an information processing device such as a personal computer used by a user. Alternatively, the processing portion 101 can be provided in a server to be accessed from a client PC via a network.

The receiving portion 103 has a function of receiving data. Examples of the data includes accounting data, image data, and text data. The receiving portion 103 receives at least accounting data and image data.

In this embodiment, accounting data is character string data written on a voucher, such as a transaction date, a product name, payment, or a client company name. Image data is image data of a voucher. Text data is character data (also referred to as character string data) extracted from image data by optical character recognition (OCR). Note that information such as a font name, a font size, coordinates, or a ruled line is embedded in image data in some cases. In the following description, information such as a font name, a font size, coordinates, or a ruled line embedded in image data is referred to as attached information.

For example, the receiving portion 103 receives unaudited accounting data. The receiving portion 103 receives image data of an unaudited voucher. The receiving portion 103 receives text data extracted from image data of an unaudited voucher in some cases.

The memory portion 102 stores a learned determination model. Note that the memory portion 102 may store data (e.g., accounting data or image data) received by the receiving portion 103.

The processing portion 101 has a function of extracting a local image feature value from image data; a function of generating a vector on the basis of accounting data using a learned determination model; a function of generating a vector on the basis of the local image feature value and text data using the learned determination model; a function of calculating similarity between the two vectors; and a function of determining whether the accounting data agrees with a voucher using the calculated similarity.

Note that the processing portion 101 may have a function of extracting attached information from image data, in addition to the function of extracting a local image feature value from image data. In this case, the processing portion 101 has a function of generating a vector on the basis of accounting data using a learned determination model; a function of generating a vector on the basis of text data and one or both of a local image feature value and attached information using the learned determination model; a function of calculating similarity between the two vectors; and a function of determining whether the accounting data agrees with the voucher using the calculated similarity.

Since the attached information is embedded in image data, the attached information can be extracted from the image data without analyzing a local image feature value. Thus, the processing portion 101 may have a function of extracting attached information from image data; a function of generating a vector on the basis of accounting data using a learned determination model; a function of generating a vector on the basis of the attached information and text data using the learned determination model; a function of calculating similarity between the two vectors; and a function of determining whether the accounting data agrees with the voucher using the calculated similarity.

The processing portion 101 may have a function of outputting a result of determining whether the accounting data agrees with the voucher.

A local image feature value is a feature value extracted from a partial region of image data. As the local image feature value, a feature value of SIFT (Scale Invariant Feature Transform), SURF (Speeded Up Robust Features), HOG (Histograms of Oriented Gradients), or the like can be used.

As a method for extracting a local image feature value, the above calculation algorithm for extracting a feature value can be used. For example, a calculation algorithm such as SIFT, SURF, or HOG can be used.

Note that extraction of a local image feature value may be performed by inference using a neural network. For example, the extraction may be performed using a convolutional neural network (CNN).

Similarity between two vectors can be calculated with the use of the cosine similarity, the covariance, the unbiased covariance, the Pearson's product-moment correlation coefficient, or the deviation pattern similarity, for example.

FIG. 1B is a diagram illustrating a structure of the processing portion 101. As illustrated in FIG. 1B, the processing portion 101 preferably includes a feature value extraction portion 101a, a vector generation portion 101b, a calculation portion 101c, and a determination portion 101d.

The feature value extraction portion 101a has a function of extracting a local image feature value from image data. Note that the feature value extraction portion 101a sometimes has a function of extracting attached information from image data, in addition to the function of extracting a local image feature value from image data. The feature value extraction portion 101a sometimes has a function of extracting attached information from image data, instead of the function of extracting a local image feature value from image data. The feature value extraction portion 101a outputs the extracted local image feature value to, for example, the vector generation portion 101b.

The vector generation portion 101b has a function of generating a vector on the basis of accounting data. Furthermore, the vector generation portion 101b has a function of generating a vector on the basis of a local image feature value and text data. Note that the vector generation portion 101b has a function of generating a vector on the basis of text data and one or both of a local image feature value and attached information in some cases. The vector generation portion 101b has a function of generating a vector on the basis of attached information and text data in some cases. The vector generation portion 101b outputs the generated vector to, for example, the calculation portion 101c.

Note that a vector is generated using a learned determination model. The learned determination model is stored in the memory portion 102. Thus, the vector generation portion 101b receives the learned determination model from the memory portion 102 to generate a vector. Note that the learned determination model may be stored in a memory portion included in the processing portion 101.

The calculation portion 101c has a function of calculating similarity between two vectors. One of the two vectors is a vector generated on the basis of accounting data, and the other of the two vectors is a vector generated on the basis of a local image feature value and text data, a vector generated on the basis of text data and one or both of a local image feature value and attached information, or a vector generated on the basis of attached information and text data. The calculation portion 101c outputs the calculated similarity to, for example, the determination portion 101d.

The determination portion 101d has a function of determining whether accounting data agrees with a voucher using similarity. For example, the determination portion 101d determines whether similarity is larger than a predetermined threshold value. The determination portion 101d has a function of outputting a determination result.

With the use of the processing portion 101 including the feature value extraction portion 101a, the vector generation portion 101b, the calculation portion 101c, and the determination portion 101d, agreement between a voucher and accounting data can be automatically checked.

Although the portions of the processing portion 101 illustrated in FIG. 1B are classified according to the functions of the processing portion 101 and independent of each other, some or all of the functions of the processing portion 101 are not necessarily independent. For example, the determination portion 101d may have the function of the calculation portion 101c. Alternatively, the determination portion 101d may have the function of the vector generation portion 101b and the function of the calculation portion 101c.

In the case of using CNN as the learned determination model, the vector generation portion 101b may calculate similarity between two vectors or determine whether accounting data agrees with a voucher using the learned determination model. That is, the vector generation portion 101b may have the function of the calculation portion 101c or the function of the determination portion 101d. In this case, the processing portion 101 may have a structure not including the calculation portion 101c and/or the determination portion 101d.

Note that the structure of the processing portion of one embodiment of the present invention is not limited to the structure of the processing portion 101 illustrated in FIG. 1B. For example, a structure of a processing portion 101A illustrated in FIG. 2B may be employed.

The processing portion 101A illustrated in FIG. 2B includes an OCR portion 101e in addition to the feature value extraction portion 101a, the vector generation portion 101b, the calculation portion 101c, and the determination portion 101d.

The OCR portion 101e has an OCR function. With the OCR portion 101e, text data can be extracted from image data. Thus, the amount of data received by the receiving portion 103 can be reduced.

As illustrated in FIG. 1A, the voucher verification system 100 may be connected to an optical character reading device 110, an input device 130, an output device 140, a memory device 150, and the like via a network 120.

The network 120 is a computer network such as the Internet, which is an infrastructure of the World Wide Web (WWW), an intranet, an extranet, a PAN (Personal Area Network), a LAN (Local Area Network), a CAN (Campus Area Network), a MAN (Metropolitan Area Network), a WAN (Wide Area Network), or a GAN (Global Area Network). Note that the network 120 includes wired or wireless communication.

The optical character reading device 110 has a function of extracting a character string (an imaged character string) included in an image as text data from image data by OCR.

The input device 130 has a function of reading a paper-based document and generating a computerized document. A scanner, a digital camera, or the like can be used as the input device 130, for example. The document in this embodiment is a voucher, for example. Note that the computerized document is in an image file format. In this case, the computerized document can be rephrased as image data.

The input device 130 may be a device for inputting data. As the input device 130, a keyboard, a pointing device, a touch panel, or the like can be used, for example. The user can input accounting data or the like with the input device 130.

The output device 140 has a function of outputting data output from the processing portion 101. As the output device 140, a display, a projector, a printer, an audio output device, a memory, or the like can be used, for example.

The memory device 150 stores accounting data and image data. The memory device 150 may store text data. The memory device 150 may be rephrased as a database.

Accounting data stored in the memory device 150 may be audited accounting data or may be both audited accounting data and unaudited accounting data. Image data stored in the memory device 150 may be image data of an audited voucher or may be both image data of an audited voucher and image data of an unaudited voucher.

Note that part or the whole of accounting data, image data, and the like to be stored in the memory device 150 may be stored in the memory portion 102.

The above is the description of the structure of the voucher verification system 100. Note that the structure of the voucher verification system of one embodiment of the present invention is not limited to the structure of the voucher verification system 100 illustrated in FIG. 1A. For example, a structure of a voucher verification system 100A illustrated in FIG. 2A may be employed.

The voucher verification system 100A illustrated in FIG. 2A includes a display portion 105 in addition to the processing portion 101, the memory portion 102, and the receiving portion 103.

The display portion 105 has a function of displaying a result of determination made by the processing portion 101. As the display portion 105, a display, a projector, a printer, or the like can be used, for example. In this way, the user can know accounting data that does not agree with a voucher in a short time. Alternatively, the user can know accounting data that has a low similarity in a short time.

One embodiment of the present invention can provide a voucher verification system for automatically checking agreement between a voucher and accounting data. Another embodiment of the present invention can provide a voucher verification system for checking agreement between a voucher and accounting data regardless of OCR performance. Another embodiment of the present invention can provide a voucher verification system for checking agreement between a voucher and accounting data with an existing optical character reading device.

### <Voucher Verification Method>

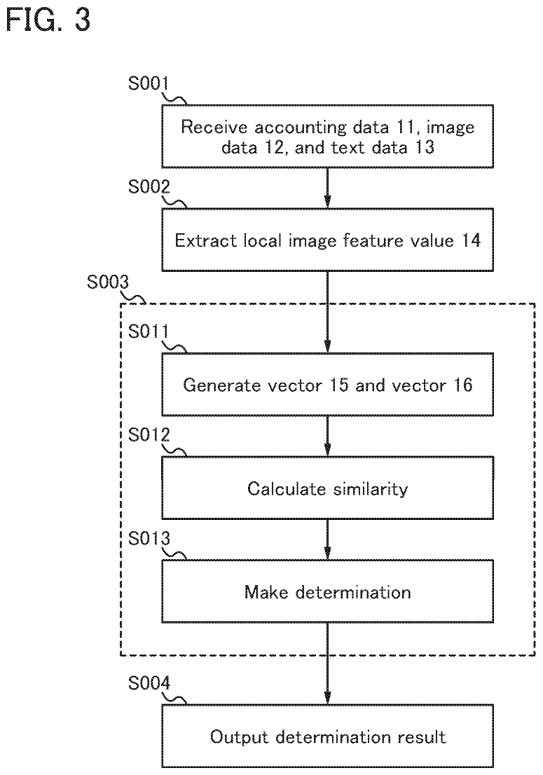

Next, a voucher verification method of one embodiment of the present invention is described with reference to FIG. 3 to FIG. 5. The voucher verification method of one embodiment of the present invention is a method for checking agreement between an unaudited voucher and accounting data input on the basis of the unaudited voucher.

Before starting the voucher verification method, accounting data 11, image data 12, and text data 13 which are based on a voucher 10 are prepared. Note that the accounting data 11 and the image data 12 which are based on the voucher 10 are sometimes prepared as data prepared before starting the voucher verification method. Here, the voucher 10 is an unaudited voucher.

The accounting data 11 is data entered into accounting software on the basis of the voucher 10.

The accounting data 11 may include data input manually by the user with reference to the voucher 10. Furthermore, the accounting data 11 may include data input mechanically on the basis of the voucher 10. That is, the accounting data 11 is composed of data input manually by the user. Alternatively, the accounting data 11 is composed of data input mechanically. Further alternatively, the accounting data 11 is composed of data input manually by the user and data input mechanically.

The image data 12 is image data of the voucher 10. In the case where the voucher 10 is a paper document, the image data 12 is preferably created by capturing an image of the voucher 10 with an input device such as a scanner or a digital camera. In the case where the voucher 10 is electronic data (in particular, image data), the electronic data itself can be used as the image data 12.

The text data 13 is data extracted from the image data of the voucher 10 by optical character recognition (OCR).

FIG. 3 is a flowchart showing an example of the voucher verification method of one embodiment of the present invention. Furthermore, FIG. 3 is a flowchart showing a procedure of processing executed by the voucher verification system of one embodiment of the present invention. Note that the above-described processing portion is used in the voucher verification method of one embodiment of the present invention.

In the voucher verification method described with reference to FIG. 3, the accounting data 11, the image data 12, and the text data 13 are prepared before starting the voucher verification method.

The voucher verification method includes Step S001 to Step S004 as shown in FIG. 3.

Step S001 is a step in which the processing portion receives the accounting data 11, the image data 12, and the text data 13.

Step S002 is a step in which the processing portion extracts a local image feature value 14. The processing portion preferably has a function of extracting a local image feature value from image data. Thus, the local image feature value 14 can be extracted from the image data 12.

Note that a local image feature value can be extracted using a calculation algorithm such as SIFT, SURF, or HOG as described above. Alternatively, a local image feature value may be extracted by inference using a neural network. For example, CNN may be used.

Step S003 is a step of checking agreement between the voucher 10 and the accounting data 11. In other words, Step S003 is a step of determining whether the accounting data 11 agrees with the voucher 10.

Step S003 includes Step S011 to Step S013 shown in FIG. 3. Here, Step S011 to Step S013 are described to describe Step S003.

Step S011 is a step in which the processing portion generates a vector 15 and a vector 16. Note that each of the vector 15 and the vector 16 is generated using a learned determination model. The learned determination model is to be described later.

The vector 15 is generated on the basis of the accounting data 11. The vector 16 is generated on the basis of the local image feature value 14 and the text data 13.

Step S012 is a step in which the processing portion calculates similarity between the vector 15 and the vector 16. The similarity can be calculated with the use of the cosine similarity, the Pearson's correlation coefficient, the deviation pattern similarity, or the like as described above.

Step S013 is a step in which the processing portion determines whether the similarity calculated in Step S012 is higher than a predetermined threshold value. In the case where the calculated similarity is higher than or equal to the threshold value, the processing portion determines that the accounting data 11 agrees with the voucher 10. In the case where the calculated similarity is lower than the threshold value, the processing portion determines that the accounting data 11 does not agree with the voucher 10.

Note that the user may set or change the threshold value in consideration of the accuracy of the learned determination model or the like.

Through Step S011 to Step S013, whether the accounting data 11 agrees with the voucher 10 can be determined. Thus, agreement between the voucher 10 and the accounting data 11 can be checked.

Step S004 is a step in which the processing portion outputs the determination result obtained in Step S003.

In this manner, agreement between an unaudited voucher and accounting data input on the basis of the voucher can be checked.

In the case where the image data 12 includes attached information, a step in which the processing portion extracts attached information may be included between Step S002 and Step S003. The processing portion preferably has a function of extracting attached information from image data in addition to the function of extracting a local image feature value from image data. In this case, in Step S011, the vector 16 is preferably generated on the basis of the text data 13 and one or both of the local image feature value 14 and the attached information.

In the case where the image data 12 includes attached information, the step in which the processing portion extracts the local image feature value 14 of Step S002 may be replaced with a step in which the processing portion extracts attached information. The processing portion preferably has a function of extracting attached information from image data. In this case, in Step S011, the vector 16 is preferably generated on the basis of the attached information and the text data 13.

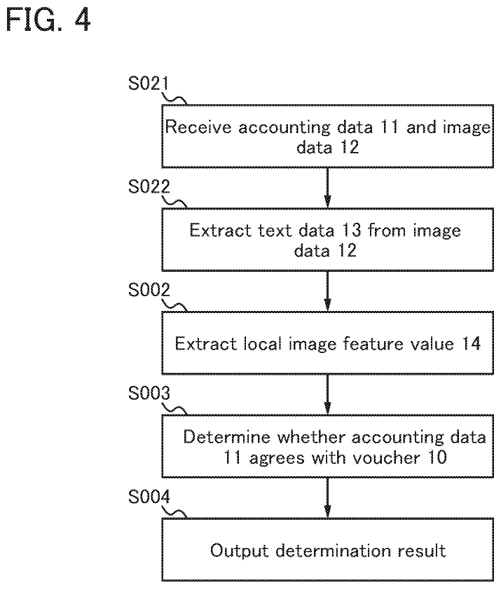

The above is the description of the example of the voucher verification method. Note that the voucher verification method of one embodiment of the present invention is not limited to the voucher verification method described with reference to FIG. 3. For example, a voucher verification method shown in a flowchart of FIG. 4 may be performed.

FIG. 4 is a flowchart showing another example of the voucher verification method of one embodiment of the present invention. Furthermore, FIG. 4 is a flowchart showing a procedure of processing executed by the voucher verification system of one embodiment of the present invention. Note that the above-described processing portion is used in the voucher verification method of one embodiment of the present invention.

In the voucher verification method described with reference to FIG. 4, the accounting data 11 and the image data 12 are prepared before starting the voucher verification method.

The voucher verification method described with reference to FIG. 4 includes Step S021, Step S022, Step S002, Step S003, and Step S004. That is, the voucher verification method described with reference to FIG. 4 is different from the voucher verification method described with reference to FIG. 3 in that Step S021 and Step S022 are included instead of Step S001.

Step S021 is a step in which the processing portion receives the accounting data 11 and the image data 12.

Step S022 is a step in which the processing portion extracts the text data 13 from the image data 12. The processing portion preferably has an optical character recognition (OCR) function. Thus, the text data 13 can be extracted from the image data 12.

Step S002, Step S003, and Step S004 are sequentially performed after Step S022. Note that the above description can be referred to for Step S002, Step S003, and Step S004.

In this manner, agreement between an unaudited voucher and accounting data input on the basis of the unaudited voucher can be checked. Note that the order of executing Step S022 and Step S002 may be changed. In the case where the processing portion includes the feature value extraction portion and the OCR portion (see FIG. 2B), Step S022 and Step S002 may be performed concurrently.

Note that another embodiment of the present invention may be a voucher verification method in which Step S022 of the voucher verification method described with reference to FIG. 4 is replaced with another step.

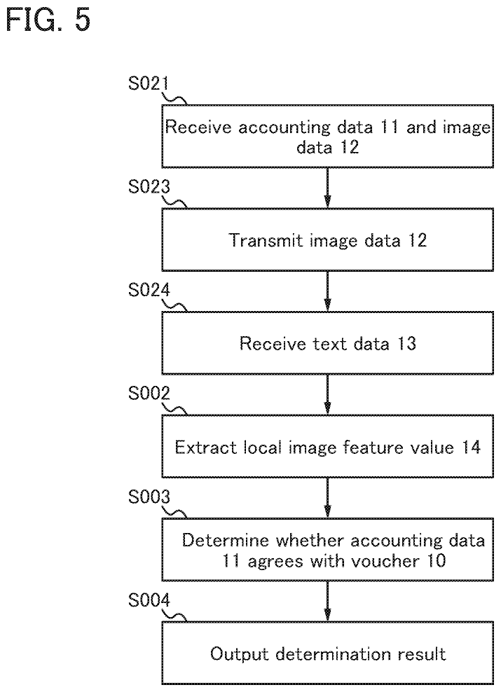

FIG. 5 is a flowchart showing another example of the voucher verification method of one embodiment of the present invention. Furthermore, FIG. 5 is a flowchart showing a procedure of processing executed by the voucher verification system of one embodiment of the present invention. Note that the above-described processing portion is used in the voucher verification method of one embodiment of the present invention.

The voucher verification method described with reference to FIG. 5 includes Step S021, Step S023, Step S024, Step S002, Step S003, and Step S004. That is, the voucher verification method described with reference to FIG. 5 is different from the voucher verification method described with reference to FIG. 4 in that Step S023 and Step S024 are included instead of Step S022. The above description can be referred to for Step S021, Step S002, Step S003, and Step S004.

Step S023 is a step in which the processing portion transmits the image data 12 to an optical character reading device. The optical character reading device receives the image data 12 and extracts the text data 13 from the image data 12.

Step S024 is a step in which the processing portion receives the text data 13 extracted in Step S023 from the optical character reading device.

The above is another example of the voucher verification method. The voucher verification method described with reference to FIG. 5 is useful in the case where the processing portion does not have an OCR function. Note that the order of executing the sequence of Step S023 and Step S024 and Step S002 may be changed, or those steps may be performed concurrently.

### <Learned Determination Model>

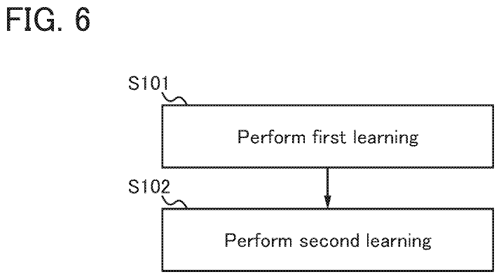

Next, a learned determination model is described with reference to FIG. 6.

As described above, a learned determination model enables a vector to be generated on the basis of text data. Furthermore, a vector can be generated on the basis of a local image feature value and text data.

FIG. 6 is a flowchart showing a method for creating a learned determination model. Note that the method for creating a learned determination model can be rephrased as a learning method of a determination model.

As shown in FIG. 6, the method for creating a learned determination model includes Step S101 and Step S102. In other words, learning of the determination model is performed by sequentially performing Step S101 and Step S102.

Step S101 is a step in which first learning is performed on the determination model. By performing the first learning, the determination model can generate a vector on the basis of text data. Note that the text data used in the first learning preferably includes audited accounting data. Note that the text data used in the first learning is not limited to audited accounting data and may include text data extracted from a document other than a voucher, such as a general document.

Step S102 is a step in which second learning is performed on the determination model on which the first learning is performed. By performing the second learning, the determination model can generate a vector on the basis of a local image feature value and text data.

The second learning is preferably supervised learning. For example, as the second learning, supervised learning with a learning data set is preferably performed. Here, the learning data set is preferably composed of a plurality of pieces of accounting data (first accounting data to n-th accounting data (n is an integer of 2 or more)), a plurality of pieces of text data (first text data to n-th text data), and a plurality of local image feature values (first local image feature value to n-th local image feature value). Specifically, it is preferable that the plurality of pieces of text data and the plurality of local image feature values be input data and vectors generated from the plurality of pieces of accounting data be teacher data (labels). The determination model can generate a vector on the basis of accounting data owing to the first learning, and thus vectors generated by the plurality of pieces of accounting data can be used as teacher data (labels). Therefore, the plurality of pieces of accounting data may be regarded as teacher data (labels).

Note that input of the i-th accounting data (i is an integer greater than or equal to 1 and smaller than or equal to n), extraction of the i-th text data by OCR, and extraction of the i-th local image feature value are performed using the same voucher. Specifically, the i-th accounting data is entered into accounting software on the basis of a voucher. The i-th text data is extracted from image data of the voucher by OCR. The i-th local image feature value is extracted from the image data of the voucher.

The second learning is preferably performed using an audited voucher. For example, the plurality of pieces of accounting data preferably include audited accounting data. The plurality of pieces of text data preferably include text data extracted from image data of an audited voucher by OCR. The plurality of local image feature values preferably include a local image feature value extracted from image data of an audited voucher.

Note that in the second learning, it is preferable that a correct label be assigned to audited accounting data, an incorrect label be assigned to data obtained from data other than audited accounting data, and the number of pieces of data to which a correct label is assigned and the number of pieces of data to which an incorrect label is assigned be substantially equal.

Audited accounting data has already been entered into accounting software. In the case where an account book is prepared using accounting software, an electronic record of a paper-based voucher is permitted. Thus, image data of an audited voucher is stored in a memory device connected to a device capable of executing accounting software in many cases. That is, text data and a local image feature value can be easily extracted from image data of an audited voucher. Therefore, a learning data set composed of the plurality of pieces of accounting data, the plurality of pieces of text data, and the plurality of local image feature values can be easily created.

Note that the plurality of pieces of accounting data, the plurality of pieces of text data, and the plurality of local image feature values may be stored in a memory portion included in the voucher verification system (e.g., the memory portion 102 illustrated in FIG. 1A), or may be stored in a memory device connected to the voucher verification system via the network 120 (e.g., the memory device 150 illustrated in FIG. 1A).

The second learning is not limited to supervised learning and may be semi-supervised learning. In semi-supervised leaning, the number of pieces of learning data included in a learning data set can be smaller than that in supervised learning; thus, a vector can be generated with high accuracy even with a small number of audited vouchers. In particular, semi-supervised learning is effective in the early stage of implementation of accounting software when the number of audited vouchers is small.

By performing the first learning and the second learning, the learned determination model can be created. In other words, by performing the first learning and the second learning, learning of the determination model is performed. Thus, the learned determination model can generate a vector on the basis of text data. Furthermore, the learned determination model can generate a vector on the basis of a local image feature value and text data. Since the first learning is performed before the second learning, the first learning can be referred to as pre-learning.

Note that the second learning may be performed on the determination model so that a vector can be generated on the basis of text data and one or both of a local image feature value and attached information. In the case where supervised learning with a learning data set is performed as the second learning, the learning data set is preferably composed of a plurality of pieces of accounting data, a plurality of pieces of text data, and one or both of a plurality of local image feature values and a plurality of pieces of attached information.

Furthermore, the second learning may be performed on the determination model so that a vector can be generated on the basis of attached information and text data. In the case where supervised learning with a learning data set is performed as the second learning, the learning data set is preferably composed of a plurality of pieces of accounting data, a plurality of pieces of text data, and a plurality of pieces of attached information.

The above is the description of the method for creating a learned determination model. Note that the learned determination model may be created in the processing portion included in the voucher verification system or may be created in a device different from the voucher verification system.

With the use of the learned determination model, a vector corresponding to character string information written on a voucher can be generated even in the case where the character string information written on the voucher cannot be extracted accurately by OCR. Thus, regardless of the performance of OCR used for extracting text data, agreement between a voucher and accounting data can be checked. That is, the accuracy of OCR itself does not need to be increased. In other words, existing OCR can be used.

### Modification Example 1

A modification example of the voucher verification system is described. Since the voucher verification system is associated with the voucher verification method and the learned determination model, a modification example of the voucher verification method and a modification example of the learned determination model are also described here.

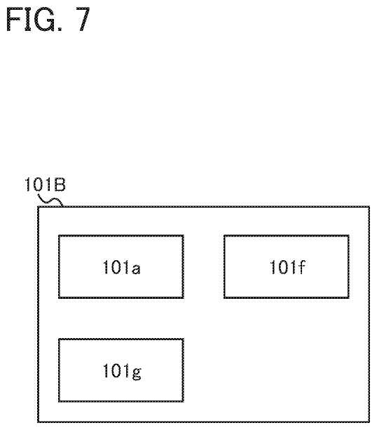

First, as a modification example of the voucher verification system, of the components included in the voucher verification system, a processing portion 101B having a structure different from those of the processing portion 101 illustrated in FIG. 1B and the processing portion 101A illustrated in FIG. 2B is described with reference to FIG. 7.

FIG. 7 is a diagram illustrating a structure of the processing portion 101B. The processing portion 101B includes the feature value extraction portion 101a, an inference portion 101f, and a determination portion 101g. Note that the above description can be referred to for the feature value extraction portion 101a.

The inference portion 101f has a function of making inference of accounting data on the basis of text data and a local image feature value. Alternatively, the inference portion 101f has a function of making inference of accounting data on the basis of one or more selected from image data, a local image feature value, and text data. That function enables obtainment of character string information written on a voucher and generation of accounting data. Furthermore, the inference portion 101f outputs accounting data generated by the inference to the determination portion 101g, for example.

The determination portion 101g has a function of determining whether accounting data agrees with a voucher. For example, the determination portion 101g determines whether accounting data received by the receiving portion 103 agrees with accounting data generated by the inference. The determination portion 101g has a function of outputting a determination result.

The inference of accounting data is preferably made using a neural network. For example, it is preferable to use CNN. Thus, CNN is preferably used as the learned determination model.

In the case where CNN is used as the learned determination model, the learned determination model may be used to determine whether accounting data agrees with a voucher. That is, the inference portion 101f may have the function of the determination portion 101g, or the determination portion 101g may have the function of the inference portion 101f. In this case, the inference portion 101f or the determination portion 101g is not necessarily included in the processing portion 101B.

With the use of the voucher verification system including the processing portion 101B, agreement between a voucher and accounting data can be automatically checked.

The processing portion 101B has a function of extracting a local image feature value from image data, a function of making inference of accounting data using a learned determination model on the basis of a local image feature value and text data, and a function of determining whether accounting data agrees with a voucher. The processing portion 101B may have a function of outputting a result of determining whether accounting data agrees with a voucher.

The processing portion 101B may have a function of extracting a local image feature value from image data, a function of extracting attached information from the image data, a function of making inference of accounting data using a learned determination model on the basis of one or more selected from image data, a local image feature value, and text data, and a function of determining whether accounting data agrees with a voucher. The processing portion 101B may have a function of outputting a result of determining whether accounting data agrees with a voucher.

The above is the description of the modification example of the voucher verification system.

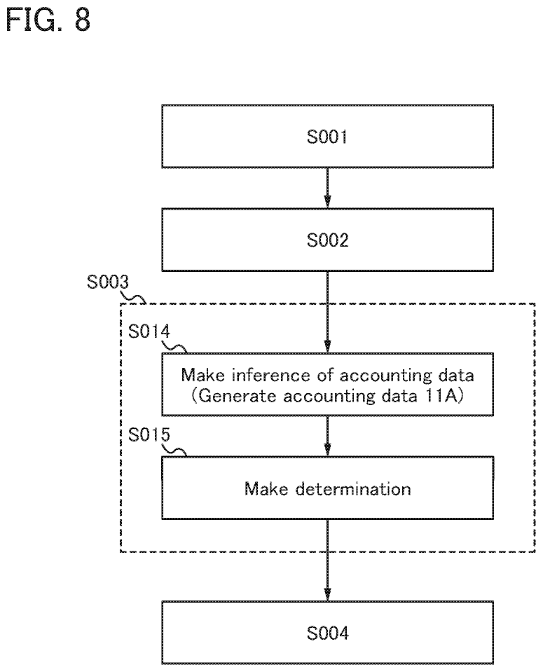

Next, a modification example of the voucher verification method is described with reference to FIG. 8. Note that the voucher verification method described with reference to FIG. 8 is performed with a processing verification system including the processing portion 101B illustrated in FIG. 7.

FIG. 8 is a flowchart showing an example of the voucher verification method. The voucher verification method described with reference to FIG. 8 is different from the voucher verification method described with reference to FIG. 3 in that Step S003 includes Step S014 and Step S015 instead of Step S011 to Step S013.

The voucher verification method shown in FIG. 8 includes Step S001 to Step S004. Step S003 includes Step S014 and Step S015. Note that the above description can be referred to for Step S001, Step S002, and Step S004.

Step S014 is a step in which the processing portion 101B makes inference of accounting data on the basis of the text data 13 and the local image feature value 14. Note that the inference of accounting data is made using a learned determination model to be described later. Hereinafter, accounting data generated by inference is referred to as accounting data 11A.

Step S015 is a step in which the processing portion 101B determines whether the accounting data 11A agrees with the accounting data 11.

Through Step S014 and Step S015, whether the accounting data 11 agrees with the voucher 10 can be determined. Thus, with the use of the voucher verification system including Step S003 including Step S014 and Step S015, agreement between a voucher and accounting data can be automatically checked.

The above is the description of the modification example of the voucher verification method.

Next, a modification example of the learned determination model is described. Note that the learned determination model is used in the voucher verification method including the steps shown in FIG. 8.

As described above, by using the learned determination model, the inference of accounting data can be made on the basis of one or more selected from image data, a local image feature value, and text data. Note that the learned determination model here is different from the learned determination model described in <Learned determination model> above in data to be generated (data to be output), and thus the method for creating a learned determination model (a learning method of a determination model) is also different.

As described above, a neural network is preferably used as the determination model. For example, CNN, a recurrent neural network (RNN), a long short-term memory (LSTM), an attention mechanism, or the like is preferably used.

Learning of the determination model is preferably supervised learning. For example, as this learning, supervised learning with a learning data set is preferably performed. Here, the learning data set is preferably composed of a plurality of pieces of accounting data (first accounting data to n-th accounting data), a plurality of pieces of text data (first text data to n-th text data), and a plurality of local image feature values (first local image feature value to n-th local image feature value). Specifically, it is preferable that the plurality of pieces of text data and the plurality of local image feature values be input data and the plurality of pieces of accounting data be teacher data (labels). Note that the learning data set may be composed of one or more selected from a plurality of pieces of accounting data, a plurality of pieces of image data, a plurality of local image feature values, and a plurality of pieces of text data.

As described in <Learned determination model> above, input of the i-th accounting data, extraction of the i-th text data by OCR, and extraction of the i-th local image feature value are performed using the same voucher.

The learning is preferably performed using an audited voucher. For example, the plurality of pieces of accounting data preferably include audited accounting data. The plurality of pieces of text data preferably include text data extracted from image data of an audited voucher by OCR. The plurality of local image feature values preferably include a local image feature value extracted from image data of an audited voucher.

Audited accounting data has already been entered into accounting software. In the case where an account book is prepared using accounting software, an electronic record of a paper-based voucher is permitted. Thus, image data of an audited voucher is stored in a memory device connected to a device capable of executing accounting software in many cases. That is, text data and a local image feature value can be easily extracted from image data of an audited voucher. Therefore, a learning data set composed of the plurality of pieces of accounting data, the plurality of pieces of text data, and the plurality of local image feature values can be easily created.

Note that the plurality of pieces of accounting data, the plurality of pieces of text data, and the plurality of local image feature values may be stored in a memory portion included in the voucher verification system (e.g., the memory portion 102 illustrated in FIG. 1A), or may be stored in a memory device connected to the voucher verification system via the network 120 (e.g., the memory device 150 illustrated in FIG. 1A).

The learning is not limited to supervised learning and may be semi-supervised learning. In semi-supervised leaning, the number of pieces of learning data included in a learning data set can be smaller than that in supervised learning; thus, accounting data can be generated with high accuracy even with a small number of audited vouchers. In particular, semi-supervised learning is effective in the early stage of implementation of accounting software when the number of audited vouchers is small.

By performing the learning, the learned determination model can be created. In other words, by performing the learning, learning of the determination model is performed. Thus, the learned determination model can make inference of accounting data on the basis of a local image feature value and text data.

The above is the description of the modification example of the learned determination model.

In the case where the voucher verification system described in <Modification example 1> is used, whether accounting data agrees with a voucher is determined on the basis of the accounting data. In the case where inferred accounting data is output as the determination result, the user can understand the determination result intuitively, as compared to the case where similarity is output. Thus, the user can know accounting data that does not agree with a voucher in a short time.

### Modification Example 2

Another modification example of the voucher verification system is described. Since the voucher verification system is associated with the voucher verification method and the learned determination model, another modification example of the voucher verification method and another modification example of the learned determination model are also described here.

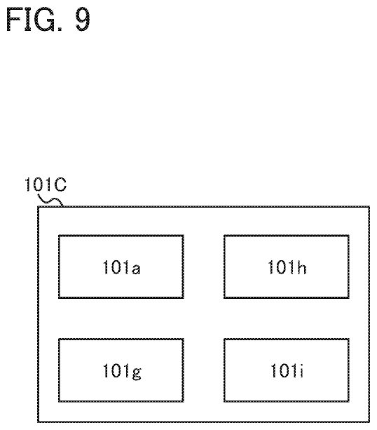

First, as another modification example of the voucher verification system, of the components included in the voucher verification system, a processing portion 101C having a structure different from those of the processing portion 101 illustrated in FIG. 1B, the processing portion 101A illustrated in FIG. 2B, and the processing portion 101B illustrated in FIG. 7 is described with reference to FIG. 9.

FIG. 9 is a diagram illustrating a structure of the processing portion 101C. The processing portion 101C includes the feature value extraction portion 101a, the determination portion 101g, an estimation portion 101h, and an inference portion 101i. Note that the above description can be referred to for the feature value extraction portion 101a and the determination portion 101g.

The estimation portion 101h has a function of estimating a client company name on the basis of a local image feature value. The estimation is preferably performed using a learned estimation model. The estimation portion 101h outputs a client company name obtained by the estimation to the inference portion 101i, for example.

The inference portion 101i has a function of making inference of accounting data on the basis of the client company name obtained by the estimation and text data. Owing to this function, character string information written on a voucher can be obtained and accounting data can be generated. Furthermore, the inference portion 101i outputs accounting data generated by the inference to the determination portion 101g, for example.

The inference of accounting data is preferably made using a neural network. For example, it is preferable to use CNN. Thus, CNN is preferably used as the learned determination model.

In the case where CNN is used as the learned determination model, the learned determination model may be used to determine whether accounting data agrees with a voucher. That is, the inference portion 101i may have the function of the determination portion 101g, or the determination portion 101g may have the function of the inference portion 101i. In this case, the inference portion 101i or the determination portion 101g is not necessarily included in the processing portion 101C.

With the use of the voucher verification system including the processing portion 101C, agreement between a voucher and accounting data can be automatically checked.

The processing portion 101C has a function of extracting a local image feature value from image data, a function of estimating a client company name using a learned estimation model on the basis of a local image feature value, a function of making inference of accounting data using the learned determination model on the basis of the client company name and text data, and a function of determining whether accounting data agrees with a voucher. The processing portion 101C may have a function of outputting a result of determining whether accounting data agrees with a voucher.

The above is the description of another modification example of the voucher verification system.

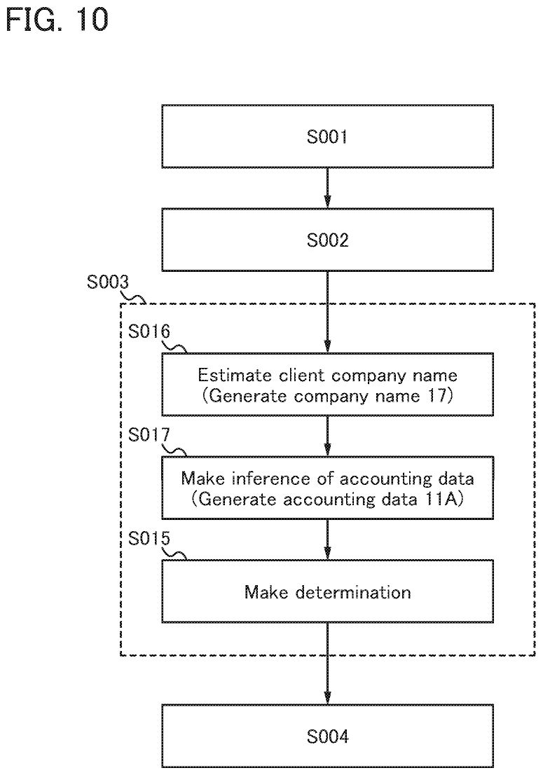

Next, another modification example of the voucher verification method is described with reference to FIG. 10. Note that the voucher verification method described with reference to FIG. 10 is performed with a processing verification system including the processing portion 101C illustrated in FIG. 9.

FIG. 10 is a flowchart showing an example of the voucher verification method. The voucher verification method described with reference to FIG. 10 is different from the voucher verification method described with reference to FIG. 8 in that Step S003 includes Step S016 and Step S017 instead of Step S014.

The voucher verification method shown in FIG. 10 includes Step S001 to Step S004. Step S003 includes Step S016, Step S017, and Step S015. Note that the above description can be referred to for Step S001, Step S002, Step S004, and Step S015.

Step S016 is a step in which the processing portion 101C estimates a client company name on the basis of the local image feature value 14. Note that the client company name is preferably estimated using a learned estimation model. Hereinafter, the client company name obtained by estimation is referred to as a company name 17.

Step S017 is a step in which the processing portion 101C makes inference of accounting data on the basis of the text data 13 and the company name 17. Note that the inference of accounting data is made using a learned determination model. Hereinafter, accounting data generated by inference is referred to as the accounting data 11A.

Through Step S016, Step S017, and Step S015, whether the accounting data 11 agrees with the voucher 10 can be determined. Thus, with the use of the voucher verification system including Step S003 including Step S016, Step S017, and Step S015, agreement between a voucher and accounting data can be automatically checked.

The above is the description of another modification example of the voucher verification method.

Note that a client company name may be estimated on the basis of image data of a voucher. In this case, a local image feature value is not necessarily extracted from the image data of the voucher. Accordingly, the processing portion 101C does not necessarily include the feature value extraction portion 101a in some cases. Moreover, Step S002 can be omitted from the voucher verification method described with reference to FIG. 8 in some cases.

### <Learned Estimation Model>

Next, a learned estimation model is described. Note that the learned estimation model is used in the voucher verification method including the steps shown in FIG. 10.

As described above, by using the learned estimation model, a client company name can be estimated on the basis of a local image feature value.

A neural network is preferably used as the estimation model. For example, an RNN, an LSTM, an attention mechanism, or the like is preferably used.

Learning of the estimation model is preferably supervised learning. For example, as this learning, supervised learning with a learning data set is preferably performed. Here, the learning data set is preferably composed of a plurality of local image feature values (first local image feature value to m-th local image feature value (m is an integer of 2 or more)) and a plurality of client company names (first client company name to m-th client company name). Specifically, it is preferable that the plurality of local image feature values be input data and the plurality of client company names be teacher data (labels).

Note that extraction of the j-th local image feature value (j is an integer greater than or equal to 1 and smaller than or equal to m) and obtainment of the j-th client company name are performed using the same voucher.

The learning is preferably performed using an audited voucher. For example, the plurality of local image feature values preferably include a local image feature value extracted from image data of an audited voucher. The plurality of client company names preferably include a client company name obtained from image data of an audited voucher or a local image feature value extracted from image data of an audited voucher. Note that the plurality of client company names may include a client company name obtained from audited accounting data.

Audited accounting data has already been entered into accounting software. In the case where an account book is prepared using accounting software, an electronic record of a paper-based voucher is permitted. Thus, image data of an audited voucher is stored in a memory device connected to a device capable of executing accounting software in many cases. That is, a local image feature value can be easily extracted from image data of an audited voucher. Therefore, a learning data set composed of the plurality of local image feature values and the plurality of client company names can be easily created.

Note that the plurality of local image feature values and the plurality of client company names may be stored in a memory portion included in the voucher verification system (e.g., the memory portion 102 illustrated in FIG. 1A), or may be stored in a memory device connected to the voucher verification system via the network 120 (e.g., the memory device 150 illustrated in FIG. 1A).

The learning is not limited to supervised learning and may be semi-supervised learning. In semi-supervised leaning, the number of pieces of learning data included in a learning data set can be smaller than that in supervised learning; thus, a client company name can be estimated with high accuracy even with a small number of audited vouchers. In particular, semi-supervised learning is effective in the early stage of implementation of accounting software when the number of audited vouchers is small.

Different companies use different voucher formats. That is, a local image feature value extracted from image data of a voucher is useful in estimating a client company name. Thus, by performing this learning, a client company name can be estimated with high accuracy. By performing the learning, the learned estimation model can be created. In other words, by performing the learning, learning of the estimation model is performed. Thus, the learned estimation model can estimate a client company name on the basis of a local image feature value.

The above is the description of the learned estimation model.

Next, another modification example of the learned determination model is described. Note that the learned determination model is used in the voucher verification method including the steps shown in FIG. 10.

As described above, by using the learned determination model, accounting data can be inferred on the basis of a client company name and text data.

A neural network is preferably used as the determination model. For example, an RNN, an LSTM, an attention mechanism, or the like is preferably used.

Learning of the determination model is preferably supervised learning. For example, as this learning, supervised learning with a learning data set is preferably performed. Here, the learning data set is preferably composed of a plurality of pieces of accounting data (first accounting data to n-th accounting data), a plurality of pieces of text data (first text data to n-th text data), and a plurality of client company names (first client company name to n-th client company name). Specifically, it is preferable that the plurality of pieces of text data and the plurality of client company names be input data and the plurality of pieces of accounting data be teacher data (labels).

As described in <Learned determination model> above, input of the i-th accounting data, extraction of the i-th text data by OCR, and obtainment of the i-th client company name are performed using the same voucher.

The learning is preferably performed using an audited voucher. For example, the plurality of pieces of accounting data preferably include audited accounting data. The plurality of pieces of text data preferably include text data extracted from image data of an audited voucher by OCR. The plurality of client company names preferably include a client company name obtained from image data of an audited voucher or a local image feature value extracted from image data of an audited voucher. Note that the plurality of client company names may include a client company name obtained from audited accounting data.

Audited accounting data has already been entered into accounting software. In the case where an account book is prepared using accounting software, an electronic record of a paper-based voucher is permitted. Thus, image data of an audited voucher is stored in a memory device connected to a device capable of executing accounting software in many cases. That is, text data and a local image feature value can be easily extracted from image data of an audited voucher. Furthermore, a client company name can be obtained from a local image feature value with the use of the processing portion 101C. Therefore, a learning data set composed of the plurality of pieces of accounting data, the plurality of pieces of text data, and the plurality of client company names can be easily created.

Note that the plurality of pieces of accounting data, the plurality of pieces of text data, and the plurality of client company names may be stored in a memory portion included in the voucher verification system (e.g., the memory portion 102 illustrated in FIG. 1A), or may be stored in a memory device connected to the voucher verification system via the network 120 (e.g., the memory device 150 illustrated in FIG. 1A).

The learning is not limited to supervised learning and may be semi-supervised learning. In semi-supervised leaning, the number of pieces of learning data included in a learning data set can be smaller than that in supervised learning; thus, accounting data can be generated with high accuracy even with a small number of audited vouchers. In particular, semi-supervised learning is effective in the early stage of implementation of accounting software when the number of audited vouchers is small.

By performing the learning, the learned determination model can be created. In other words, by performing the learning, learning of the determination model is performed. Thus, the learned determination model can make inference of accounting data on the basis of a client company name and text data.

Different companies use different voucher formats. That is, a client company name is useful in identifying a transaction date, a product name, payment, or the like included in text data. Thus, by performing this learning, accounting data can be inferred with high accuracy.

The above is the description of another modification example of the learned determination model.

One embodiment of the present invention can provide a voucher verification method for automatically checking agreement between a voucher and accounting data. Another embodiment of the present invention can provide a voucher verification method for checking agreement between a voucher and accounting data regardless of OCR performance. Another embodiment of the present invention can provide a voucher verification method for checking agreement between a voucher and accounting data using existing OCR.

At least part of this embodiment can be implemented in combination with the other embodiment described in this specification as appropriate.

### Embodiment 2

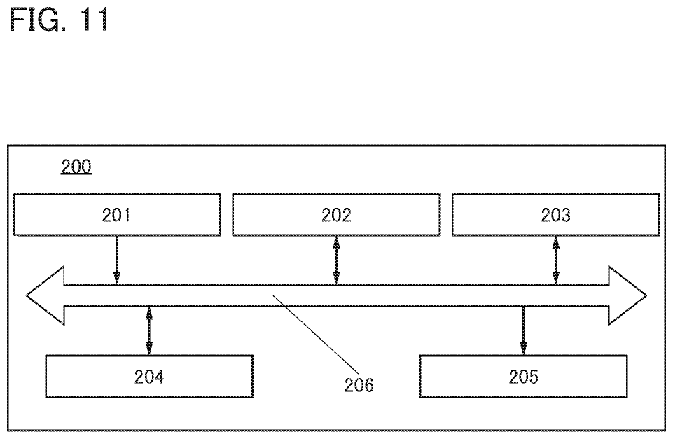

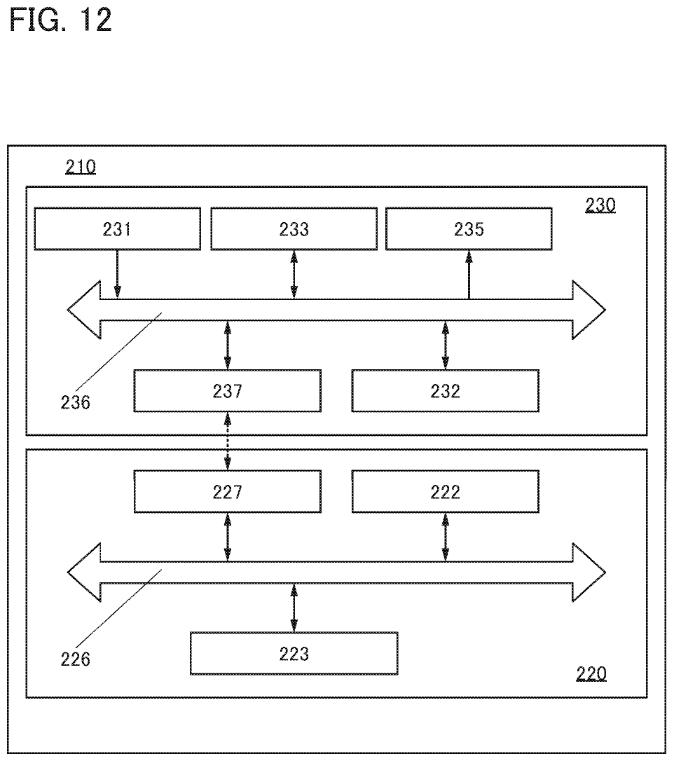

In this embodiment, a configuration of hardware of a voucher verification system of one embodiment of the present invention is described with reference to FIG. 11 and FIG. 12.

The voucher verification system of this embodiment can automatically check agreement between a voucher and accounting data by the voucher verification method described in Embodiment 1.

### Configuration Example 1 of Voucher Verification System

FIG. 11 is a block diagram of a voucher verification system 200. Note that in a block diagram attached to this specification, components are classified according to their functions and shown as independent blocks; however, it is practically difficult to completely separate the components according to their functions, and one component may have a plurality of functions.

Moreover, one function can relate to a plurality of components; for example, processing performed by a processing portion 202 can be executed on different servers depending on the processing.

The voucher verification system 200 includes at least the processing portion 202. The voucher verification system 200 in FIG. 11 further includes a receiving portion 201, a memory portion 203, a database 204, a display portion 205, and a transmission path 206.

### [Receiving Portion 201]

The receiving portion 201 receives image data from the outside of the voucher verification system 200. The image data is image data of an unaudited voucher, for example, and corresponds to the image data 12 in Embodiment 1. The receiving portion 201 may receive text data from the outside of the voucher verification system 200. The text data is text data extracted from image data of an unaudited voucher, for example, and corresponds to the text data 13 in Embodiment 1. The image data, the text data, or the like received by the receiving portion 201 is supplied to the processing portion 202, the memory portion 203, or the database 204 via the transmission path 206.

Examples of a method for inputting image data, text data, or the like include key input with a keyboard, a touch panel, or the like, audio input with a microphone, image input with a scanner, a camera, or the like, reading from a recording medium, and obtainment via communication.

The voucher verification system 200 may have an optical character recognition (OCR) function. This enables characters contained in image data to be recognized and text data to be extracted. For example, the processing portion 202 may have the function. Alternatively, the voucher verification system 200 may further include an OCR portion having the function.

### [Processing Portion 202]

The processing portion 202 has a function of performing processing using data supplied from the receiving portion 201, the memory portion 203, the database 204, or the like. The processing portion 202 can supply a processing result to the memory portion 203, the database 204, the display portion 205, or the like.

The processing portion 202 includes the processing portion 101 described in Embodiment 1. That is, the processing portion 202 has a function of extracting a local image feature value from image data; a function of generating a vector on the basis of accounting data using a learned determination model; a function of generating a vector on the basis of the local image feature value and text data using the learned determination model; a function of calculating similarity between the two vectors; and a function of determining whether the accounting data agrees with a voucher using the calculated similarity. The processing portion 202 may have a function of outputting a result of determining whether the accounting data agrees with the voucher.

A transistor including a metal oxide in its channel formation region may be used in the processing portion 202. The transistor has an extremely low off-state current; therefore, with the use of the transistor as a switch for retaining electric charge (data) that has flowed into a capacitor serving as a memory element, a long data retention period can be ensured. When at least one of a register and a cache memory included in the processing portion 202 has such a feature, the processing portion 202 can be operated only when needed, and otherwise can be off while data processed immediately before turning off the processing portion 202 is stored in the memory element. In other words, normally-off computing is possible and the power consumption of the voucher verification system can be reduced.

In this specification and the like, a transistor including an oxide semiconductor in its channel formation region is referred to as an Oxide Semiconductor transistor (OS transistor). A channel formation region of an OS transistor preferably includes a metal oxide.

The metal oxide included in the channel formation region preferably contains indium (In). When the metal oxide included in the channel formation region is a metal oxide containing indium, the carrier mobility (electron mobility) of the OS transistor increases. The metal oxide included in the channel formation region preferably contains an element M. The element M is preferably aluminum (Al), gallium (Ga), or tin (Sn). Other elements that can be used as the element M are boron (B), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that two or more of the above elements may be used in combination as the element M in some cases. The element M is an element having high bonding energy with oxygen, for example. The element M is an element having higher bonding energy with oxygen than indium, for example. The metal oxide included in the channel formation region preferably contains zinc (Zn). The metal oxide containing zinc is easily crystallized in some cases.

The metal oxide included in the channel formation region is not limited to the metal oxide containing indium. For example, the metal oxide included in the channel formation region may be a metal oxide that does not contain indium and contains zinc, a metal oxide that contains gallium, or a metal oxide that contains tin, e.g., zinc tin oxide or gallium tin oxide.

Furthermore, a transistor including silicon in a channel formation region may be used in the processing portion 202.

In the processing portion 202, a transistor including an oxide semiconductor in a channel formation region and a transistor including silicon in a channel formation region may be used in combination.

The processing portion 202 includes, for example, an arithmetic circuit, a central processing unit (CPU), or the like.

The processing portion 202 may include a microprocessor such as a DSP (Digital Signal Processor) or a GPU (Graphics Processing Unit). The microprocessor may be constructed with a PLD (Programmable Logic Device) such as an FPGA (Field Programmable Gate Array) or an FPAA (Field Programmable Analog Array). The processing portion 202 can interpret and execute instructions from various programs with the use of a processor to process various types of data and control programs. The programs that can be executed by the processor are stored in at least one of a memory region of the processor and the memory portion 203.

The processing portion 202 may include a main memory. The main memory includes at least one of a volatile memory such as a RAM and a nonvolatile memory such as a ROM.

A DRAM (Dynamic Random Access Memory), an SRAM (Static Random Access Memory), or the like is used as the RAM, for example, and a memory space is virtually assigned as a work space for the processing portion 202 to be used. An operating system, an application program, a program module, program data, a look-up table, and the like which are stored in the memory portion 203 are loaded into the RAM for execution. The data, program, and program module which are loaded into the RAM are each directly accessed and operated by the processing portion 202.

In the ROM, a BIOS (Basic Input/Output System), firmware, and the like for which rewriting is not needed can be stored. As examples of the ROM, a mask ROM, an OTPROM (One Time Programmable Read Only Memory), an EPROM (Erasable Programmable Read Only Memory), and the like can be given. As examples of the EPROM, a UV-EPROM (Ultra-Violet Erasable Programmable Read Only Memory) which can erase stored data by ultraviolet irradiation, an EEPROM (Electrically Erasable Programmable Read Only Memory), a flash memory, and the like can be given.

### [Memory Portion 203]

The memory portion 203 has a function of storing a program to be executed by the processing portion 202. In addition, the memory portion 203 has a function of storing the learned determination model described in Embodiment 1. The memory portion 203 may also have a function of storing data received by the receiving portion 201, a processing result generated by the processing portion 202, or the like.

The memory portion 203 includes at least one of a volatile memory and a nonvolatile memory. For example, the memory portion 203 may include a volatile memory such as a DRAM or an SRAM. For example, the memory portion 203 may include a nonvolatile memory such as an ReRAM (Resistive Random Access Memory), a PRAM (Phase-change Random Access Memory), an FeRAM (Ferroelectric Random Access Memory), an MRAM (Magnetoresistive Random Access Memory), or a flash memory. The memory portion 203 may include a recording media drive such as a hard disk drive (HDD) or a solid state drive (SSD).

### [Database 204]

The voucher verification system 200 may include the database 204. For example, the database 204 has a function of storing data associated with audited vouchers (e.g., the first accounting data to the n-th accounting data, the first text data to the n-th text data, and the first local image feature value to the n-th local image feature value which are described in Embodiment 1). Alternatively, the database 204 may store data associated with a voucher that has gone through agreement check.

Note that the memory portion 203 and the database 204 are not necessarily separated from each other. For example, the voucher verification system 200 may include a memory unit that has both the functions of the memory portion 203 and the database 204.

Note that memories included in the processing portion 202, the memory portion 203, and the database 204 can each be regarded as an example of a non-transitory computer readable storage medium.

### [Display Portion 205]

The display portion 205 has a function of displaying a result of processing by the processing portion 202. For example, the display portion 205 has a function of displaying a result of determination made by the processing portion 202. The display portion 205 may also have a function of displaying image data of a voucher, accounting data, or the like.

Note that the voucher verification system 200 may include an output portion. The output portion has a function of supplying data to the outside.

### [Transmission Path 206]

The transmission path 206 has a function of transmitting a variety of data. The data transmission and reception among the receiving portion 201, the processing portion 202, the memory portion 203, the database 204, and the display portion 205 can be performed via the transmission path 206. For example, image data of a voucher, text data extracted from image data of a voucher, or the like is transmitted and received via the transmission path 206.

### Configuration Example 2 of Voucher Verification System

FIG. 12 is a block diagram of a voucher verification system 210. The voucher verification system 210 includes a server 220 and a terminal 230 (e.g., a personal computer).

The server 220 includes a processing portion 222, a memory portion 223, a transmission path 226, and a communication portion 227. The server 220 may further include a receiving portion, an output portion, an OCR portion, a database, and the like, although these are not illustrated in FIG. 12.

The terminal 230 includes a receiving portion 231, a processing portion 232, a memory portion 233, a display portion 235, a transmission path 236, and a communication portion 237. The terminal 230 may further include a database, an OCR portion, and the like, although these are not illustrated in FIG. 12.

In the voucher verification system 210, the receiving portion 231 of the terminal 230 receives image data. The image data is image data of an unaudited voucher and corresponds to the image data 12 described in Embodiment 1. The receiving portion 231 of the terminal 230 may receive text data. The text data is, for example, text data extracted from image data of an unaudited voucher and corresponds to the text data 13 described in Embodiment 1. The image data, the text data, and the like are transmitted from the communication portion 237 of the terminal 230 to the communication portion 227 of the server 220.

The image data, the text data, and the like received by the communication portion 227 are stored in the memory portion 223 via the transmission path 226. Alternatively, the image data, the text data, and the like may be supplied directly to the processing portion 222 from the communication portion 227.

High processing capability is required for the extraction of a local image feature value and the determination of whether accounting data agrees with a voucher which are described in Embodiment 1. The processing portion 222 included in the server 220 has higher processing capability than the processing portion 232 included in the terminal 230. Thus, it is preferable that the processing portion 222 perform the extraction of a local image feature value and the determination of whether accounting data agrees with a voucher.

Then, the processing portion 222 outputs a determination result. The determination result is supplied directly to the communication portion 227 from the processing portion 222. The determination result is transmitted from the communication portion 227 of the server 220 to the communication portion 237 of the terminal 230. The determination result is displayed on the display portion 235 of the terminal 230. Note that the determination result may be stored in the memory portion 223 or the memory portion 233.

### [Processing Portion 222 and Processing Portion 232]

The processing portion 222 has a function of performing processing with the use of data supplied from the memory portion 223, the communication portion 227, or the like. The processing portion 232 has a function of performing processing with the use of data supplied from the receiving portion 231, the memory portion 233, the display portion 235, the communication portion 237, or the like. The description of the processing portion 202 can be referred to for the processing portion 222 and the processing portion 232. The processing portion 222 preferably has higher processing capability than the processing portion 232.

### [Memory Portion 223]

The memory portion 223 has a function of storing a program to be executed by the processing portion 222. The memory portion 223 has a function of storing data associated with an audited voucher (e.g., accounting data, image data, and text data), a processing result generated by the processing portion 222, data input to the communication portion 227, and the like. The description of the memory portion 203 can be referred to for the memory portion 223.

### [Memory Portion 233]

The memory portion 233 has a function of storing a program to be executed by the processing portion 232. The memory portion 233 has a function of storing an arithmetic operation result generated by the processing portion 232, data received by the receiving portion 231, data input to the communication portion 237, and the like. The description of the memory portion 203 can be referred to for the memory portion 233.

### [Transmission Path 226 and Transmission Path 236]

The transmission path 226 and the transmission path 236 have a function of transmitting data. Data transmission and reception among the processing portion 222, the memory portion 223, and the communication portion 227 can be carried out via the transmission path 226. Data transmission and reception among the receiving portion 231, the processing portion 232, the memory portion 233, the display portion 235, and the communication portion 237 can be carried out via the transmission path 236.

### [Communication Portion 227 and Communication Portion 237]

The server 220 and the terminal 230 can transmit and receive data with the use of the communication portion 227 and the communication portion 237. As the communication portion 227 and the communication portion 237, a hub, a router, a modem, or the like can be used. Data may be transmitted or received through wire communication or wireless communication (e.g., radio waves or infrared rays).

Communication between the server 220 and the terminal 230 may be performed by connection with a computer network such as the Internet, which is an infrastructure of the World Wide Web (WWW), an intranet, an extranet, a PAN (Personal Area Network), a LAN (Local Area Network), a CAN (Campus Area Network), a MAN (Metropolitan Area Network), a WAN (Wide Area Network), or a GAN (Global Area Network).

### [Receiving Portion 231]

The description of the receiving portion 201 can be referred to for the receiving portion 231.

### [Display Portion 235]

The description of the display portion 205 can be referred to for the display portion 235.

At least part of this embodiment can be implemented in combination with the other embodiment described in this specification as appropriate.

### REFERENCE NUMERALS

10: voucher, 11: accounting data, 11A: accounting data, 12: image data, 13: text data, 14: local image feature value, 15: vector, 16: vector, 17: company name, 100: voucher verification system, 100A: voucher verification system, 101: processing portion, 101a: feature value extraction portion, 101A: processing portion, 101b: vector generation portion, 101B: processing portion, 101c: calculation portion, 101C: processing portion, 101d: determination portion, 101e: OCR portion, 101f: inference portion, 101g: determination portion, 101h: estimation portion, 101i: inference portion, 102: memory portion, 103: receiving portion, 105: display portion, 110: optical character reading device, 120: network, 130: input device, 140: output device, 150: memory device, 200: voucher verification system, 201: receiving portion, 202: processing portion, 203: memory portion, 204: database, 205: display portion, 206: transmission path, 210: voucher verification system, 220: server, 222: processing portion, 223: memory portion, 226: transmission path, 227: communication portion, 230: terminal, 231: receiving portion, 232: processing portion, 233: memory portion, 235: display portion, 236: transmission path, 237: communication portion.

1. A voucher verification method for checking agreement between accounting data and a voucher using a processing portion,
wherein the processing portion receives first accounting data, image data of a first voucher, and first text data, extracts a first local image feature value from the image data of the first voucher, generates a first vector on the basis of the first accounting data using a learned determination model, generates a second vector on the basis of the first local image feature value and the first text data using the learned determination model, calculates similarity between the first vector and the second vector, makes determination of whether the first accounting data agrees with the first voucher using the similarity, and outputs a result of the determination, and
wherein the first text data is data extracted from the image data of the first voucher by optical character recognition.

2. A voucher verification method for checking agreement between accounting data and a voucher using a processing portion,
wherein the processing portion receives first accounting data and image data of a first voucher, extracts first text data from the image data of the first voucher by optical character recognition, extracts a first local image feature value from the image data of the first voucher, generates a first vector on the basis of the first accounting data using a learned determination model, generates a second vector on the basis of the first local image feature value and the first text data using the learned determination model, calculates similarity between the first vector and the second vector, makes determination of whether the first accounting data agrees with the first voucher using the similarity, and outputs a result of the determination.

3. The voucher verification method according to claim 1,
wherein, in the learned determination model, first learning for generating a vector is performed using second text data, and second learning for generating a vector is performed using a second local image feature value, third text data, and second accounting data after the first learning,
wherein the second accounting data is data corresponding to a second voucher,
wherein the second local image feature value is extracted from image data of the second voucher, and
wherein the third text data is data extracted from the image data of the second voucher.

4. The voucher verification method according to claim 3,
wherein the second learning is supervised learning.

5. The voucher verification method according to claim 1,
wherein the first accounting data comprises data input manually by a user with reference to the first voucher.

6. The voucher verification method according to claim 1,
wherein the first accounting data comprises data input mechanically on the basis of the first voucher.

7. A voucher verification system comprising:
a memory portion;
a receiving portion; and
a processing portion,
wherein the memory portion stores a learned determination model,
wherein the receiving portion is configured to receive first accounting data, image data of a first voucher, and first text data,
wherein the processing portion is configured to extract a first local image feature value from the image data of the first voucher, a to generate a first vector on the basis of the first accounting data using the learned determination model, to generate a second vector on the basis of the first local image feature value and the first text data using the learned determination model, to calculate similarity between the first vector and the second vector, and to make determination of whether the first accounting data agrees with the first voucher using the calculated similarity, and
wherein the first text data is data extracted from the image data of the first voucher by optical character recognition.

8. The voucher verification system according to claim 7,
wherein, in the learned determination model, first learning for generating a vector is performed using second text data, and second learning for generating a vector is performed using a second local image feature value, third text data, and second accounting data after the first learning,
wherein the second accounting data is data corresponding to a second voucher,
wherein the second local image feature value is extracted from image data of the second voucher, and
wherein the third text data is data extracted from the image data of the second voucher.

9. The voucher verification system according to claim 7, further comprising a display portion,
wherein the display portion is configured to display a result of the determination.

10. The voucher verification method according to claim 2,
wherein, in the learned determination model, first learning for generating a vector is performed using second text data, and second learning for generating a vector is performed using a second local image feature value, third text data, and second accounting data after the first learning,
wherein the second accounting data is data corresponding to a second voucher,
wherein the second local image feature value is extracted from image data of the second voucher, and
wherein the third text data is data extracted from the image data of the second voucher.

11. The voucher verification method according to claim 10,
wherein the second learning is supervised learning.

12. The voucher verification method according to claim 2,
wherein the first accounting data comprises data input manually by a user with reference to the first voucher.

13. The voucher verification method according to claim 2,
wherein the first accounting data comprises data input mechanically on the basis of the first voucher.

14. The voucher verification system according to claim 8, further comprising a display portion,
wherein the display portion is configured to display a result of the determination.
